(19) United States
(12) Patent Application Publication
(10) Pub. No.: US 2009/0076890 A1
(43) Pub. Date: Mar. 19, 2009

(54) SYSTEM AND METHOD FOR VALUING MEDIA INVENTORY FOR THE DISPLAY OF MARKETING CAMPAIGNS ON A PLURALITY OF MEDIA DEVICES AT PUBLIC LOCATIONS

(75) Inventors: Paul Dixon, Seattle, WA (US); Jeremy York, Bothell, WA (US); Thomas C. Opdycke, Bellevue, WA (US); Wan-Chung William Wu, Bellevue, WA (US)

Correspondence Address: PERKINS COIE LLP;PATENT-SEA, P.O. BOX 1247, SEATTLE, WA, 98111-1247, US

(73) Assignee: DS-IQ, Inc., Bellevue, WA (US)

(21) Appl. No.: 12/234,555

(22) Filed: Sep. 19, 2008

Related U.S. Application Data
(60) Provisional application No. 60/973,673, filed on Sep. 19, 2007.
(60) Provisional application No. 61/049,622, filed on May 1, 2008.

(51) Int. Cl. G06Q 30/00; G06Q 10/00

(52) U.S. Cl. 705/10; 705/14

(57) ABSTRACT

A system and method to value media inventory for the display of marketing campaigns on a network of media devices. The system measures past marketing campaign performance and efficiency and assigns a campaign impact value to the advertising opportunity achieved by the execution of past campaigns. Summaries of the campaign impact of past campaigns are stored in a benchmarking archive. The system uses the data contained in the benchmarking archive in order to calculate the value of the network's media inventory, namely the capacity or availability of the network of media devices to play or display future campaigns. The value of the media inventory is used to appropriately assign media inventory to new campaigns that are to be shown on the network of media devices.

### CROSS-REFERENCE TO RELATED APPLICATIONS

This application claims the benefit of U.S. Provisional Patent Application Ser. No. 60/973,673, entitled “SUMMARIZING PERFORMANCE OF AND VALUING INVENTORY UTILIZED BY MARKETING CAMPAIGNS, SUCH AS THOSE PRESENTED VIA ELECTRONIC SIGNS, SPEAKERS, KIOSKS AND OTHER MEDIA DEVICES IN PUBLIC PLACES” filed on Sep. 19, 2007, which is incorporated herein by this reference in its entirety. This application also claims the benefit of U.S. Provisional Patent Application Ser. No. 61/049,622 entitled “DYNAMIC INVENTORY MANAGEMENT FOR SYSTEMS SUCH AS ELECTRONIC SIGNS, KIOSKS, AND OTHER MEDIA DEVICES IN PUBLIC PLACES” filed on May 1, 2008, which is incorporated herein by this reference in its entirety. This application describes systems and methods that can be used independently, or in conjunction with commonly assigned U.S. patent application Ser. No. 11/619,506 (MEASURING PERFORMANCE OF MARKETING CAMPAIGNS, SUCH AS THOSE PRESENTED VIA ELECTRONIC SIGNS, SPEAKERS, KIOSKS AND OTHER MEDIA DEVICES IN PUBLIC PLACES). This application also describes inventions that can be used independently, or in conjunction with commonly assigned U.S. Patent Application 60/493,263 (SYSTEM AND METHOD FOR DELIVERING AND OPTIMIZING MEDIA PROGRAMMING IN PUBLIC SPACES).

### BACKGROUND

Many purchasing and spending decisions are made while people are shopping in a store or occupying some other public place. To influence these decisions, manufacturers, vendors and retailers make effective use of product packaging and printed point-of-purchase advertising. The use of media devices—video displays, speakers, etc.—in stores, malls, and other public spaces promises to revolutionize in-store marketing by providing dynamic, captivating content. Retailers, network operators and advertisers would like to measure the benefits of such a system.

### BRIEF DESCRIPTION OF THE DRAWINGS

FIG. 1 is a flow diagram of a process for analyzing a marketing campaign presented on a network of media devices, programmatically archiving the impact of the campaign, and calculating a value of media inventory based on stored campaign impact.

FIG. 2 is a flow diagram of a process that uses campaign impact information to determine whether a campaign continues to run on a network of media devices.

FIG. 3 is a flow diagram of a process that uses campaign impact information in a prequalification process to determine which campaigns should be presented on a network of media devices.

FIG. 4 is a flow diagram of a process for allocating media inventory between different marketing campaigns.

### DETAILED DESCRIPTION

Data associated with audience response to marketing and records of content played or displayed on media devices often comes from two or more disparate systems that have no interaction. Even when the systems are integrated, it may not be easy to integrate the different types of data measured by each system. For example, a customer may be intrigued by a marketing campaign displayed on a flat-screen display in a retail store environment; as a result, the customer purchases the promoted product. The purchase transaction record will typically be recorded through retail store's point-of-sale (POS) network, while the marketing campaign is broadcast via a separate digital signage network. Without methods to correlate these sources of data, traditional marketing analysis can only rely on analyzing the pure behavior response data (such as changes in sales over time) as their performance benchmark. The result is an aggregated, simplified analysis which is unable to determine how other factors impact campaign performance.

In addition, the impact of promotional campaigns on audience behavior can exhibit different characteristics over time and in conjunction with other variables of interest. Aggregated audience behavior data lacks the detail required to measure these changes (particularly if the play frequency or nature of the content is changing over time), and exposure metrics fail to address the audience response. Moreover, variability in the reach (i.e., how many people see the advertising campaign), effectiveness (i.e., how well the audience responds to the campaign), and cost make it difficult to assess the value of a network of media devices or the relative effectiveness of different campaigns (or the same campaign as run at different times and/or on different networks of media devices).

To aid in the assessment of the value of a network of media devices or the selection of campaigns to run on the network, a system and method to value media inventory for the display of marketing campaigns on the network of media devices is disclosed. The system measures past marketing campaign performance and efficiency and assigns monetary or other valuation (the “campaign impact”) to the advertising opportunity achieved by the execution of past campaigns. Summaries of the campaign impact of past campaigns are stored in a benchmarking archive. The system uses the data contained in the benchmarking archive in order to calculate the value of the network's media inventory, namely the capacity or availability of the network of media de vices to play or display future campaigns. The valuation of the media inventory ma y take into account all aspects of availability, location, and/or capability associated with the network, such as, for example, the total number of minutes that a campaign may be presented on media devices, the number of campaigns that can be presented, the number of media devices on which a campaign can be deployed, the location of media devices, the capability of media devices (e.g., size, resolution, color, type of media), etc.

In some embodiments, the valuation of media inventory is based on metrics tailored to either the advertiser (for example, a manufacturer purchasing advertising time on a retailer's in-store network), the party that owns and/or manages the available media inventory (for example, a retailer that owns an in-store digital network), or a combination of these and other entities (for example, when a retailer advertises its own products on its own in-store digital network). The valuation of media inventory can be phrased in either absolute or relative terms (i.e., an amount of media inventory can be said to be worth a certain amount in general, or can have its value defined in the context of a specific choice of marketing campaign). The calculation of an absolute or relative valuation by the system utilizes a wide range of specific metrics, including but not limited to: incremental sales units or dollars attributed to the campaign, the marginal value of incremental sales dollars, and other metrics.

In some embodiments, the campaign impact data stored in the benchmarking archive may be used by the system to facilitate comparisons between campaigns that did not run concurrently. For example, advertisers might wish to compare the performance of similar or the same creative treatments at different times of year. As another example, advertisers may wish to compare the performance of different creative treatments over time. In another example, retailers may choose to admit or not admit new marketing campaigns into their networks based on their expected performance in comparison with historical benchmarks.

The campaign impact data contained in the benchmarking archive may also be used for a variety of other purposes by retailers, advertisers, and the system operator. For example, an advertiser may be evaluating multiple different networks for running a campaign that encourages the audience to pick up a free sample of a new product from a nearby display. Initial campaigns (or similar previous campaigns) yield a range of results for the incremental increase in adoption of the free samples due to exposure to the campaign across the different networks. The retailer can provide information which can be used to create projections of the future dollar value of the audience members who requested the free sample (as based on future purchases, brand equity, etc). The projections can be used to evaluate the cost effectiveness of the available media inventory on the different networks, and hence allow the advertiser to buy campaign time more efficiently in the future.

In some embodiments, the valuation of media inventory generated by the system may be used to generate rate cards. “Rate cards” are pricing guidelines or rules associated with inventory types and inventory commitment types. For example, a rate card might be derived from a base price that is automatically adjusted upward for inventory reservations made further into the future (to reflect the option value of reserving inventory ahead of time). The enforcement of rates cards may be a manual or system-driven exercise. Rate cards may be enforced more or less flexibly or rigidly, depending on many factors, such as the network, underlying business realities (e.g., whether the network is broadly oversold or undersold), other business objectives, etc. Rate cards may also be made dynamic by being based on the state of an auction or other bidding environment.

Various embodiments of the invention will now be described. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

### Determination of Campaign Impact and Valuation of Media Inventory

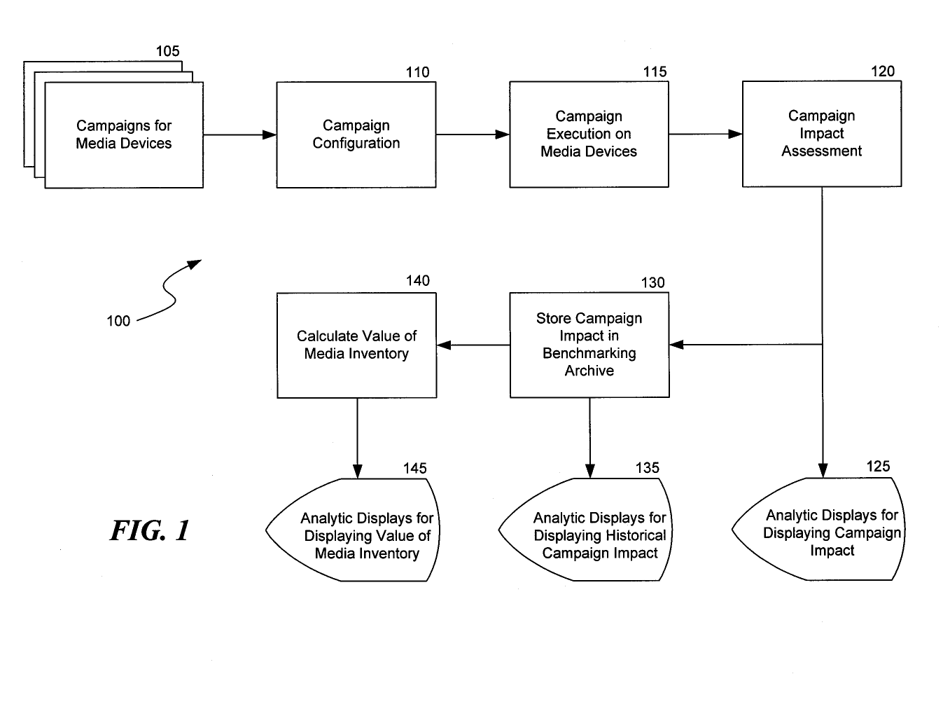

FIG. 1 is a flow diagram of a process 100 for analyzing a marketing campaign presented on a network of media devices, programmatically archiving the campaign impact, and calculating a value of media inventory based on the stored campaign impact. At a step 105, a variety of campaigns may be created for delivery over a network of media devices that are deployed in public locations. Details about representative networks over which a campaign may be delivered are contained in U.S. patent application Ser. No. 11/619,506, entitled “MEASURING PERFORMANCE OF MARKETING CAMPAIGNS, SUCH AS THOSE PRESENTED VIA ELECTRONIC SIGNS, SPEAKERS, KIOSKS AND OTHER MEDIA DEVICES IN PUBLIC PLACES,” filed on Jan. 3, 2007, which is herein incorporated by this reference in its entirety. At a step 110, the campaigns may be modified in whole or in part for the specific objectives of the campaign or subsets of the campaign. For example, overall play commitments may be configured, content may be scheduled against specific play objectives or business rules or business objectives, etc. The system may store campaign configuration data that summarizes how each campaign is configured. At a step 115, one or more campaigns are executed via the network's media devices. At a step 120, campaign impact is assessed based on received campaign impact data. In some embodiments, the campaign impact may be measured by the value of incremental sales that were driven by the campaign. For example, if a marketing campaign that was presented in a chain of stores or other retail environments during a certain time period resulted in $100K of incremental sales, the campaign impact may be said to be $100K. If another campaign ran in the same chain of stores or retail environments during the same time, but generated $150K in incremental sales, the campaign impact may be said to be $150K. In general, campaign impact may be measured by a variety of economic metrics including but not limited to incremental unit sales, gross revenues from incremental unit sales, and marginal revenue from incremental unit sales.

The determined campaign impact may be used by the system in a variety of ways, and the system may use a variety of methodologies to analyze and summarize campaign impact across a large number of campaigns, include scoring systems, linear programs (i.e., constrained optimization, with linear or non-linear objective functions), neural networks, genetic algorithms, genetic computing, machine learning systems, simulated annealing models, stochastic modeling, etc. At a step 125, the campaign impact is displayed or summarized and displayed for users on one or more analytic displays.

At a step 130, the system stores records of campaign impact in a benchmarking archive, for example, a relational database that may include campaign and content metadata, network metadata, summarized aggregate campaign impact or performance, detailed drill-downs into campaign impact or performance, campaign impact or performance as a function of the duration of the campaign, individual campaign content items, play frequency, audience demographic, time or day, day of week, seasonality, year, holiday/non-holiday period, etc. At a step 135, the campaign benchmarking archived data is made available by the system for viewing and analysis via one or more analytic displays.

At a step 140, the determined campaign impact may also be used by the system to predict the value of the media inventory of the network. For example, if a marketing campaign in a chain of stores or other retail environments displayed during a certain time period had an impact of $100K, the value of the media inventory for future presentation of campaigns at the same locations, time, and for a similar campaign may be determined to have an equal value. As another example, if two campaigns were displayed at similar locations during similar times, and one of the campaigns had a campaign impact of $100K and the other campaign had a campaign impact of $150K, then the system may assign a $125K value to the media inventory for comparable future presentation (i.e., comparable campaigns presented at similar time slots and locations). Those skilled in the art will appreciate that other mathematical operations may be used to assign a value to media inventory based on historical campaign impact data. For example, the mean, median, maximum, or some percentile could be used to come up with a single valuation number based on historical campaign impact data across multiple campaigns. As more campaign impact data is accumulated by the system, the valuation of the media inventory improves since the system is able to use the greater historical record to more accurately value the media inventory based on number of media devices, time, and similarity of campaigns.

Those skilled in the art will appreciate that in lieu of or in addition to campaign impact data, other data pertaining to the campaign may also be used to assign a value to media inventory. For example, inventory can be valued using the price paid or rate card value of past campaigns, the impact of past campaigns on audience behavior (measured in terms of long term customer value, etc), and other descriptive campaign data. In each case, the mean, median, maximum, or some percentile could be used to come up with a single number if there is stored data associated with multiple campaigns. The valuation may be based on one or more of the foregoing types of data, with data types weighted to emphasize or deemphasize the importance of the corresponding measurement.

In some embodiments, a predictive technique (for example, a neural network, a generalized linear model, a clustering approach) might be used to assess campaign impact and other data in order to predict the value of the media inventory. Given the value of past campaigns and the inventory that they covered as inputs, the model is fit or trained to match the given data. Some predictive techniques may be able to generate an estimate for the value simply based on the inventory type, without specifying the campaign attributes. Alternatively, the media inventory type and a set of assumptions about what types of campaigns are likely in the future can be fed into the predictive system to generate a range of possible values for the media inventory based on likely future campaigns. The range of values output from the predictive technique can be summarized by mean, median, maximum, or some percentile to generate an inventory value.

The predicted value of the media inventory in the network may be stored in the benchmarking archive or in another location accessible by the system. At a step 145, the value of the media inventory is made available by the system for viewing and analysis via one or more analytic displays

### Use of Campaign Impact to Determine Campaign Continuation

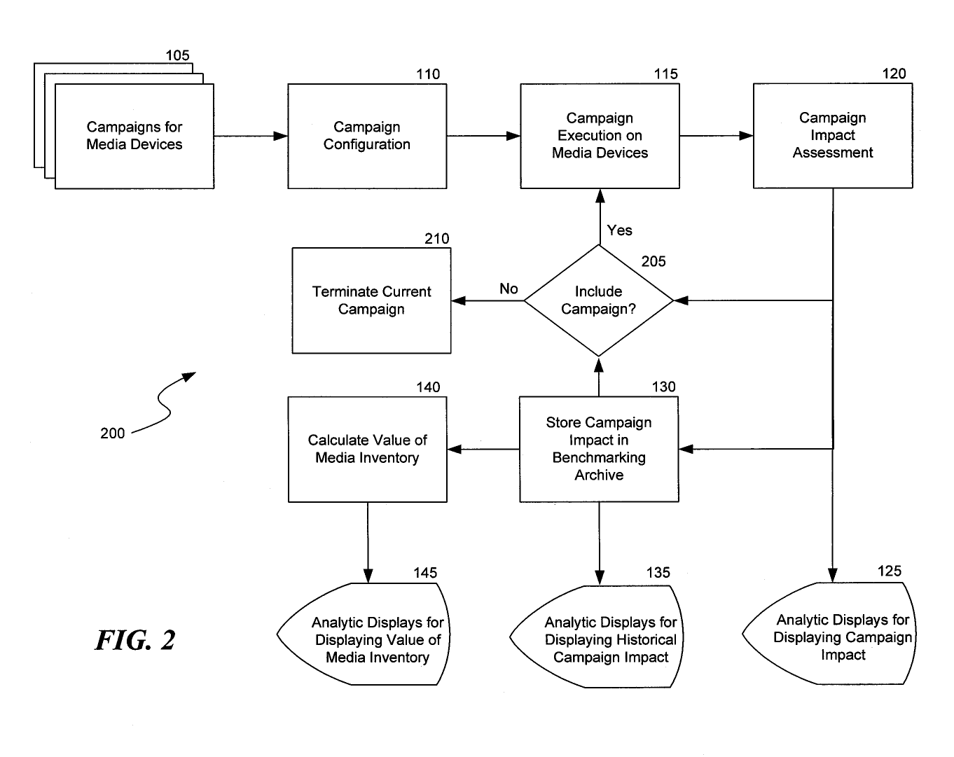

FIG. 2 is a flow diagram of a process 200 that uses campaign impact information to determine whether a campaign continues to run on a network of media devices. As depicted in FIG. 2, at a decision step 205 the current campaign impact is compared with the stored records of historical impact of other campaigns (either historical campaigns that have already run to completion, or campaigns running concurrently, on the same or different networks of media devices), By comparing the current campaign impact with expected campaign impact (as measured by historical performance of campaigns), the system may determine whether the current campaign should continue to run on the network of media devices. If the current campaign is exceeding the historical performance of similar campaigns presented under similar circumstances, the system may allow the current campaign to continue to run. If the current campaign is not exceeding the historical performance of similar campaigns presented under similar circumstances, however, the system may halt the continued use of the current campaign at a step 210. In this fashion, poorly-performing campaigns may be halted and replaced by campaigns that may have a greater success at performing at or above historical norms. In some embodiments, campaigns begin in a provisional status on the network of media devices, and are only continued after a certain trial period if they exceed certain performance benchmarks based for example on historical observations of other campaigns on the same or different networks.

### Use of Campaign Impact for Campaign Prequalification

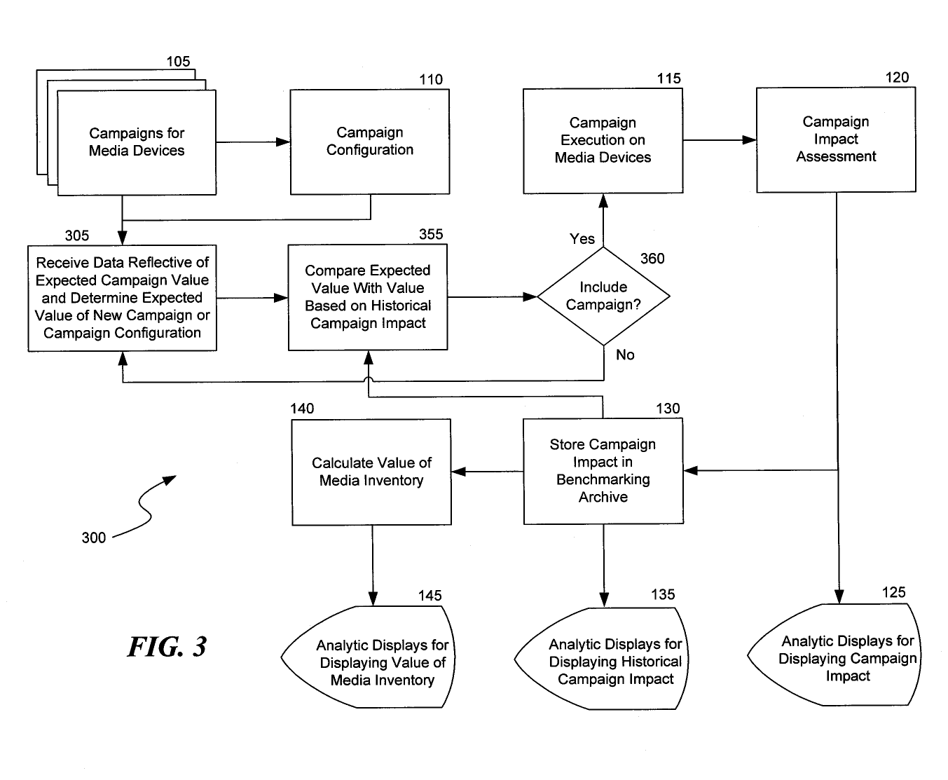

FIG. 3 is a flow diagram of a process 300 that uses campaign impact information in a prequalification process to determine which campaigns should be presented on a network of media devices. At a step 305, the system receives sufficient data about a new marketing campaign to allow the system to determine an expected value of a new campaign or campaign configuration. In some embodiments, the received data may be an anticipated value of the marketing campaign as assessed by an advertiser. The anticipated value may be a total media value of the campaign, which includes a combination of both the direct economic value of the campaign (i.e., the amount of sales lift that the campaign is expected to generate) as well as the brand value of the campaign (i.e., the goodwill value that the campaign may generate). In some embodiments, the received data may be a bid amount that the advertiser is willing to pay to place the marketing campaign on the network or a value from the rate card that is charged the advertiser.

In addition to explicit amounts that an advertiser is willing to pay to place the marketing campaign, the expected value of a campaign may be projected based on other known characteristics of the campaign. For example, the expected customer impact of the campaign could be projected by assuming that it will behave identical to the most comparable campaign in the benchmarking archive, or by using the mean, median, maximum, or some percentile of the impact associated with similar past campaigns. The value could be based on a combination of actual or likely price to be paid, the value of expected audience impact, and other factors. A predictive approach (for example, a neural network, a generalized linear model, a clustering approach) that uses campaign descriptors and inventory types may also be used to predict the overall value of the campaign. Given the value of past campaigns and the inventory that they covered as inputs, the predictive model is fit or trained to match the given data. The inventory type and descriptive information about the campaign are fed into the predictive system to generate the likely value of the campaign on the specified inventory type.

At a step 355, once an expected value calculation has been performed, the system compares the expected value against historical campaign impact data for similar campaigns. At a decision step 360, the system decides whether to execute the campaign. If the expected value of the new campaign or campaign configuration exceeds the historical campaign impact data for similar campaigns, then the campaign is executed at step 115. If, however, the expected value of the new campaign or campaign configuration does not exceed the historical campaign impact data for similar campaigns, the system returns to step 305 to select a different new campaign or campaign configuration. The system thereby selects only those new campaigns or campaign configurations that are expected to have better performance than historical campaigns.

In some embodiments, the campaign impact benchmarking archive stored at step 130, is used to inform both a prequalification decision at step 360, as well as to determine whether campaigns currently running are allowed to continue running at a campaign continuation decision such as step 205 in process 200.

### Use of Valuation of Media Inventory for Allocating Media Inventory

In some embodiments, the system uses valuations of media inventory to provide guidance to advertisers to allow advertisers to select between multiple potential sources of media inventory. For example, an advertiser may base a willingness to pay on the valuation of the media inventory in question via measures of prior or expected future campaign performance. Additionally, advertisers may tailor the specific choice of metric describing campaign performance to the specific goals of the upcoming campaign that is being planned. For example, measurements of campaign performance may have demonstrated that certain available media inventory is more effective at driving sales during times of price promotion, whereas other available media inventory is more effective at driving sales during periods of regular full pricing of the advertised product. In this case, an advertiser might base its choice and/or willingness to pay based on the presence or absence of planned upcoming promotional events, in conjunction with historical performance and the price of the media inventory.

In some embodiments, the system uses valuations of media inventory to aid in selling that inventory to prospective advertisers. For example, a retailer may employ historical measurements of the performance of many campaigns to create an average valuation of its available media inventory. Such valuations may be published in the form of rate cards to prospective advertisers. These valuations may be based on many possible measures of campaign performance, including incremental unit sales, incremental gross revenue from those sales, or incremental marginal (net) revenue from those sales. The granularity of these valuations with respect to the media inventory in question may be generalized and aggregated, or may be made more specific. For example, a retailer may define its available media inventory in terms of such detailed attributes as hour of day, day of week, week of year, holidays, seasonal events, underlying demographic composition of the stores where the media inventory is available, different media channels within their stores, etc.

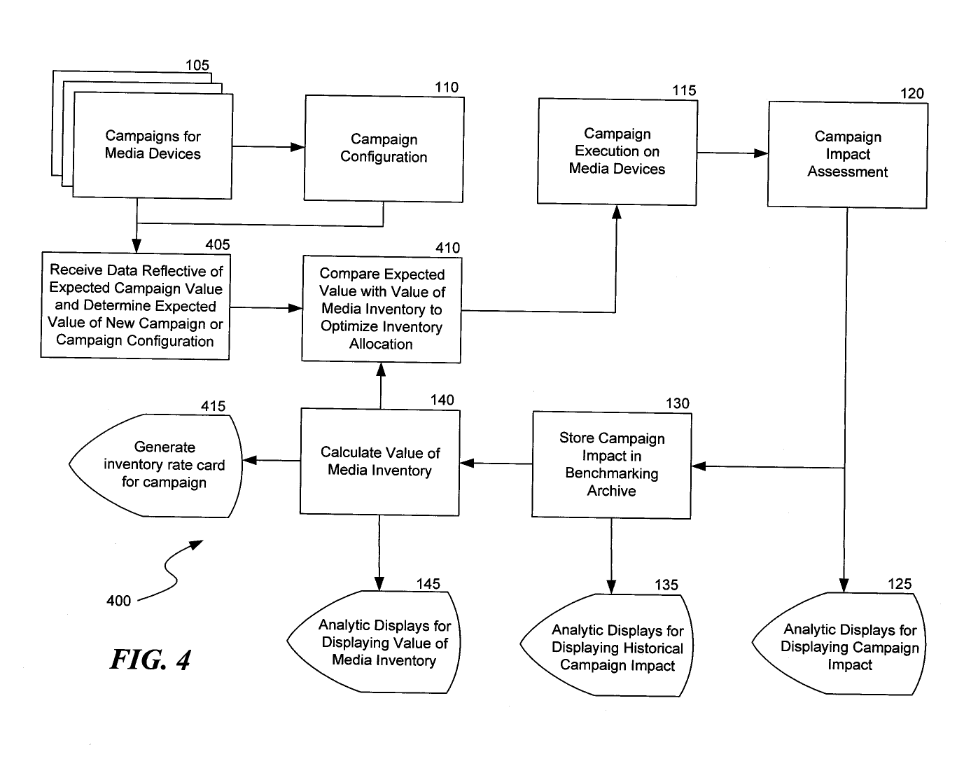

FIG. 4 is a flow diagram of a process 400 for allocating media inventory between different marketing campaigns. In some embodiments, the process differentiates media inventory into guaranteed and discretionary components as part of an optimization strategy for allocating media inventory to campaigns. Guaranteed inventory is that required to meet minimum commitments for some or all campaigns. For example, advertisers purchasing campaigns on a network may have been guaranteed a certain number of plays of their content items, a certain absolute amount or percentage of available play time on the network's media devices, or a certain audience reach over the course of their campaigns, where audience reach itself could range from the general (i.e., an overall GRP commitment) to the specific (i.e., GRP commitments for many different audience demographics, times of day, days of week, weeks or other periods of the year, etc.). Discretionary inventory is the media inventory that remains to be allocated once all advertiser campaign commitments have been satisfied. For example, total inventory less guaranteed inventory could be equated to discretionary inventory.

As depicted in FIG. 4, at a step 405 the system the system receives sufficient data about a new marketing campaign to allow the system to determine an expected value of a new campaign or campaign configuration. In some embodiments, the received data may be an anticipated value of the marketing campaign as assessed by an advertiser. The anticipated value may be a total media value of the campaign, which includes a combination of both the direct economic value of the campaign (i.e., the amount of sales lift that the campaign is expected to generate) as well as the brand value of the campaign (i.e., the goodwill value that the campaign may generate). In some embodiments, the received data may be a bid amount that the advertiser is willing to pay to place the marketing campaign on the network or a value from the rate card that is charged the advertiser.

In addition to explicit amounts that an advertiser is willing to pay to place the marketing campaign, the expected value of a campaign may be projected based on other known characteristics of the campaign. For example, the expected customer impact of the campaign could be projected by assuming that it will behave identical to the most comparable campaign in the benchmarking archive, or by using the mean, median, maximum, or some percentile of the impact associated with similar past campaigns. The value could be based on a combination of actual or likely price to be paid, the value of expected audience impact, and other factors. A predictive approach (for example, a neural network, a generalized linear model, a clustering approach) that uses campaign descriptors and inventory types may also be used to predict the overall value of the campaign. Given the value of past campaigns and the inventory that they covered as inputs, the predictive model is fit or trained to match the given data. The inventory type and descriptive information about the campaign are fed into the predictive system to generate the likely value of the campaign on the specified inventory type.

At a step 410, the system compares the calculated expected value of the new campaign or campaign configuration with the value of the available media inventory as determined by step 140. As part of the comparison, the system seeks to optimize the assignment of the available inventory to the new campaign. That is, the system attempts to identify those portions of the available media inventory having values that are equal to or are less than the expected value of the new campaign or campaign configuration. In this fashion, the system operator is able to maximize advertising revenue while still providing the advertiser with an optimum set of inventory that can meet the desired campaign goals of the advertiser. If the expected value of the new campaign or campaign configuration is less than value of the media inventory, and if other campaigns of higher value are competing for the same media inventory, it is in the fiscal interest of the system operator to forgo the presentation of the new campaign or campaign configuration in favor of the higher valuation campaigns.

In some embodiments, in addition to the predicted value of the media inventory, the system may take into account the historical campaign impact data, campaign configuration data, impact data of currently running campaigns, and expected future value of new campaigns when making the optimization assessment. When the system performs such a multi-factor analysis, the system may first determine whether the economic value of the new campaign is equal or greater to the value that the system placed on the media inventory (i.e., that the campaign value exceeds the anticipated value that can be realized from the media inventory). If the campaign value exceeds the anticipated value that can be realized from the media inventory, the system may assess other factors to determine whether it still would be in the best interest of the system operator to forgo the new campaign in order to offer the media inventory for use by another campaign.

Embodiments of the system which allocate media inventory between advertising campaigns could create allocation decisions for discretionary inventory while taking guaranteed inventory and prior inventory commitments to certain campaigns as constraints in its decision making. Other criteria can also guide the optimization performed by the system, including minimum or maximum total number of plays, minimum or maximum total time present on the media device, maximum or minimum frequency of play (i.e., number of times a campaign's content appears in a given play list or play loop), content standards (i.e., some campaigns may not be included on some or all of a particular network's media devices), advertiser budgets (i.e., in the case when an advertiser can afford some but not all of the available discretionary inventory to be allocated to its campaign), and other criteria.

In such embodiments, allocation decisions might include some or all of a network's media devices, and span some or all of the time periods over which the given campaigns are scheduled or intended to run. The allocation decisions produced by such embodiments can be based on a variety of measures of campaign performance (i.e., campaign impact data), including but not limited to: incremental unit sales, incremental gross sales revenue, or incremental net sales revenue. If desired, any of these measures may be normalized by or otherwise related to or transformed via measures of advertising effort, audience exposure, or a combination of these and other measures. In some embodiments, other measures of campaign impact or audience response are also used, including but not limited to: audience dwell time, audience engagement with the media, or any other desired audience behavior the media stimulus promotes.

In some embodiments, at a step 415 the system may also utilize the value of the media inventory to generate an inventory rate card that may be provided to potential advertisers or marketers. Because the inventory rate card is correlated to the historical record of campaign impact, the rate card may result in higher revenue for the system operator since advertisers may be willing to pay higher rates if they are presented with evidence of the performance of similarly-situated campaigns in the past.

The automated calculation of rate cards may employ various types of input data. For example, it may be desirable for rate cards to depend on the scarcity of available inventory, as when the managers of a network desire to charge a premium price for inventory types that are in short supply, or when the managers of a network wish to lower the price for inventory types for which there is an abundance. Similarly, there are many scenarios in which network managers may desire to charge a different price for what would otherwise be the same inventory type, depending on how far in the future (or how far into the future) a campaign is booked. For example, it may be desirable to charge a premium for the privilege of booking inventory far in advance, reflecting the option value lost by the managers of the network by virtue of their having committed their inventory to a particular campaign or campaigns early on in a planning cycle. Conversely, it might also be desirable to grant a discount to strategic partners or users of a network, in exchange for the volume of inventory they seek to reserve and/or purchase, and the duration over which they wish to use it. Similarly, inventory being bought on short notice might be heavily discounted, if network managers deem there are no better alternatives for its use—or alternately, sold at a premium, in return for the privilege of being allowed to book a campaign at the last moment.

In another embodiment, the rate cards themselves become a function of network audience size or characteristics, and/or past, present, or expected future campaign performance on the inventory types in question. For example, consider a network of media devices employed in public locations (e.g., grocery, mass retail, finance, mall, restaurants etc.), in which at least a partial goal of those utilizing the network for their campaigns is to drive some direct purchase or other short-term behavioral response on the part of the audience consuming the media. In such a situation, it is likely that the magnitude and composition of the audience will itself vary over time (by time of day, day of week, season, holiday, week of the year, etc.). In such a case, the inventory will have a different intrinsic value, as audience size and/or responsiveness to the media changes over time. This difference in value could be expressed in general terms, as when the system returns the same rate card for inventory irrespective of the details of any particular campaign, or it could be made idiosyncratic to one or a set of specific campaigns, as when the system returns different rate cards for campaigns that are expected to perform better than for those expected to perform worse when executed on the same inventory. For example, network managers of a media network may wish to charge a different price depending on audience exposure, reach and frequency, various audience behavioral response, or the expected performance of the campaign in terms of incremental sales of the item or items featured in the campaign, or of the category those featured items belong to, or even depending on the marginal rate of return on the sales of those items.

In some embodiments, the systems operate at a variety of different temporal frequencies. For example, in some embodiments, it is employed when new advertising campaigns are considered for inclusion. In some embodiments, it is employed periodically and on an ongoing basis to update media inventory allocation decisions as campaigns progress and time passes.

Those skilled in the art will appreciate that the system described herein may be implemented on any computing system or device. Suitable computing systems or devices include personal computers, server computers, multiprocessor systems, microprocessor-based systems, network devices, minicomputers, mainframe computers, distributed computing environments that include any of the foregoing, and the like. Such computing systems or devices may include one or more processors that execute software to perform the functions described herein. Processors include programmable general-purpose or special-purpose microprocessors, programmable controllers, application specific integrated circuits (ASICs), programmable logic devices (PLDs), or the like, or a combination of such devices. Software may be stored in memory, such as random access memory (RAM), read-only memory (ROM), flash memory, or the like, or a combination of such components. Software may also be stored in one or more storage devices, such as magnetic or optical based disks, flash memory devices, or any other type of non-volatile storage medium for storing data. Software may include one or more program modules which include routines, programs, objects, components, data structures, and so on that perform particular tasks or implement particular abstract data types. The functionality of the program modules may be combined or distributed as desired in various embodiments. The term “media devices” is used throughout to apply to any display or audio device that is capable of delivering text, audio, video, or any combination thereof to an audience.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/We claim:

1. A computer-implemented method of allocating media inventory to a new marketing campaign to enable the new marketing campaign to be presented to natural persons on a plurality of media devices at public locations, the computer-implemented method comprising:
receiving data that characterizes the performance of two or more marketing campaigns that were presented to audiences on a network of media devices at public locations;
analyzing the received data to assess the impact of the two or more marketing campaigns on the audiences that were exposed to the two or more marketing campaigns;
predicting a value of at least some of the media inventory available on the network of media devices in the future based on the assessed impact of the two or more marketing campaigns on the audiences;
receiving data that characterizes an expected value of a new marketing campaign that is to be presented on the network of media devices; and
comparing the predicted value of at least some of the media inventory available on the network in the future with the expected value of the new marketing campaign and assigning media inventory to the new marketing campaign based at least in part on the comparison of the expected value and the predicted value.

2. The computer-implemented method of claim 1, further comprising:
storing the assessed impact of the two or more marketing campaigns in an archive; and
retrieving the assessed impact of the two or more marketing campaigns from the archive in order to predict the value of at least some of the media inventory.

3. The computer-implemented method of claim 1, wherein the new marketing campaign has not been previously presented on the network of media devices.

4. The computer-implemented method of claim 1, wherein the new marketing campaign is a new configuration of a campaign that was previously-presented on the network of media devices.

5. The computer-implemented method of claim 1, wherein the received data characterizing the expected value is selected from the group consisting of a total media value, a bid value, or a rate card value.

6. The computer-implemented method of claim 1, wherein the media inventory is characterized by a time attribute.

7. The computer-implemented method of claim 6, wherein the time attribute is selected from the group consisting of hour of the day, day of the week, week of the year, holidays, and seasonal events.

8. The computer-implemented method of claim 1, wherein the media inventory is characterized by a location attribute.

9. The computer-implemented method of claim 8, wherein the location attribute is selected from the group consisting of media device, set of media devices, public location, and set of public locations.

10. The computer-implemented method of claim 1, further comprising generating a rate card based on the predicted value of at least some of the media inventory available on the network.

11. The computer-implemented method of claim 1, wherein the impact of the two or more marketing campaigns is measured by performance metrics selected from the group consisting of incremental unit sales, gross revenues from incremental unit sales, and marginal revenue from incremental unit sales.

12. The computer-implemented method of claim 1, wherein the received data that characterizes the performance of the two or more marketing campaigns includes campaign configuration data.

13. The computer-implemented method of claim 12, wherein campaign configuration data is selected from the group consisting of campaign content, campaign metadata, network metadata, play frequency, audience demographic, time of day, day of week, seasonality, and year.

14. The computer-implemented method of claim 1, wherein media inventory is characterized as guaranteed inventory or discretionary inventory.

15. The computer-implemented method of claim 14, wherein the media inventory that is assigned to the new marketing campaign is discretionary inventory.

16. The computer-implemented method of claim 1, wherein media inventory is assigned to the new marketing campaign if the expected value of the new marketing campaign exceeds the calculated value of the allocated media inventory.

17. The computer-implemented method of claim 1, further comprising assigning media inventory to the new marketing campaign based at least in part on a factor selected from the group consisting of historical campaign impact data, campaign configuration data, and impact data of currently running campaigns.

18. A computer-readable storage medium storing computer-executable instructions that, when executed, cause a computing system to perform a method for of allocating media inventory to a new marketing campaign to enable the new marketing campaign to be presented to natural persons on a plurality of media devices at public locations, the method comprising:
receiving data that characterizes the performance of two or more marketing campaigns that were presented to audiences on a network of media devices at public locations;
analyzing the received data to assess the impact of the two or more marketing campaigns on the audiences that were exposed to the two or more marketing campaigns;
predicting a value of at least some of the media inventory available on the network of media devices in the future based on the assessed impact of the two or more marketing campaigns on the audiences;
receiving data that characterizes an expected value of a new marketing campaign that is to be presented on the network of media devices; and
comparing the predicted value of at least some of the media inventory available on the network in the future with the expected value of the new marketing campaign and assigning media inventory to the new marketing campaign based at least in part on the comparison of the expected value and the predicted value.

19. The computer-readable storage medium of claim 18, the method further comprising:
storing the assessed impact of the two or more marketing campaigns in an archive; and
retrieving the assessed impact of the two or more marketing campaigns from the archive in order to predict the value of at least some of the media inventory.

20. The computer-readable storage medium of claim 18, wherein the new marketing campaign has not been previously presented on the network of media devices.

21. The computer-readable storage medium of claim 18, wherein the new marketing campaign is a new configuration of a campaign that was previously-presented on the network of media devices.

22. The computer-readable storage medium of claim 18, wherein the received data characterizing the expected value is selected from the group consisting of a total media value, a bid value, or a rate card value.

23. The computer-readable storage medium of claim 18, wherein the media inventory is characterized by a time attribute.

24. The computer-readable storage medium of claim 23, wherein the time attribute is selected from the group consisting of hour of the day, day of the week, week of the year, holidays, and seasonal events.

25. The computer-readable storage medium of claim 18, wherein the media inventory is characterized by a location attribute.

26. The computer-readable storage medium of claim 25, wherein the location attribute is selected from the group consisting of media device, set of media devices, public location, and set of public locations.

27. The computer-readable storage medium of claim 18, wherein the method further comprises generating a rate card based on the predicted value of at least some of the media inventory available on the network.

28. The computer-readable storage medium of claim 18, wherein the impact of the two or more marketing campaigns is measured by performance metrics selected from the group consisting of incremental unit sales, gross revenues from incremental unit sales, and marginal revenue from incremental unit sales.

29. The computer-readable storage medium of claim 18, wherein the received data that characterizes the performance of the two or more marketing campaigns includes campaign configuration data.

30. The computer-readable storage medium of claim 18, wherein campaign configuration data is selected from the group consisting of campaign content, campaign metadata, network metadata, play frequency, audience demographic, time of day, day of week, seasonality, and year.

31. The computer-readable storage medium of claim 18, wherein media inventory is characterized as guaranteed inventory or discretionary inventory.

32. The computer-readable storage medium of claim 31, wherein the media inventory that is assigned to the new marketing campaign is discretionary inventory.

33. The computer-readable storage medium of claim 18, wherein media inventory is assigned to the new marketing campaign if the expected value of the new marketing campaign exceeds the calculated value of the allocated media inventory.

34. The computer-readable storage medium of claim 18, the method further comprising assigning media inventory to the new marketing campaign based at least in part on a factor selected from the group consisting of historical campaign impact data, campaign configuration data, and impact data of currently running campaigns.

35. A system for allocating media inventory to a new marketing campaign to enable the new marketing campaign to be presented to natural persons on a plurality of media devices at public locations, the system comprising:
a receiver configured to:
receive performance data that characterizes the performance of two or more marketing campaigns that were presented to audiences on a network of media devices at public locations; and
receive campaign data that characterizes an expected value of a new marketing campaign that is to be presented on the network of media devices;
an analysis component configured to analyze the received performance data to assess the impact of the two or more marketing campaigns on the audiences that were exposed to the marketing campaigns and predict a value of at least some of the media inventory available in the future on the network of media devices based on the assessed impact on the audiences; and
an inventory allocation component configured to compare the predicted value of at least some of the media inventory available on the network in the future with the expected value of the new marketing campaign and assign media inventory to the new marketing campaign based at least in part on the comparison of the expected value and the predicted value.

36. The system of claim 35, further comprising an archive configured to store the assessed impact of the two or more marketing campaigns.

37. The system of claim 35, wherein the received campaign data is selected from the group consisting of a total media value, a bid value, or a rate card value.

38. The system of claim 35, wherein the media inventory is characterized by a time attribute.

39. The system of claim 38, wherein the time attribute is selected from the group consisting of hour of the day, day of the week, week of the year, holidays, and seasonal events.

40. The system of claim 35, wherein the media inventory is characterized by a location attribute.

41. The system of claim 42, wherein the location attribute is selected from the group consisting of media device, set of media devices, public location, and set of public locations.

42. The system of claim 35, wherein the analysis component is further configured to generate a rate card based on the predicted value of at least some of the media inventory available on the network.

43. The system of claim 35, wherein the impact of the two or more marketing campaigns is measured by performance metrics selected from the group consisting of incremental unit sales, gross revenues from incremental unit sales, and marginal revenue from incremental unit sales.

44. The system of claim 35, wherein the received performance data includes campaign configuration data.

45. The system of claim 44, wherein campaign configuration data is selected from the group consisting of campaign content, campaign metadata, network metadata, play frequency, audience demographic, time of day, day of week, seasonality, and year.

46. The system of claim 35, wherein the allocation component assigns media inventory to the new marketing campaign if the expected value of the new marketing campaign exceeds the calculated value of the allocated media inventory.

47. The system of claim 35, wherein the allocation component is further configured to assign media inventory to the new marketing campaign based at least in part on a factor selected from the group consisting of historical campaign impact data, campaign configuration data, and impact data of currently running campaigns.
